(19) United States
(12) Patent Application Publication
(10) Pub. No.: US 2008/0047391 A1
(43) Pub. Date: Feb. 28, 2008

(54) EFFICIENT AUXILIARY POWER SUPPLY

(76) Inventor: Steven W. Bissell, Copley, OH (US)

Correspondence Address: HAHN LOESER & PARKS, LLP, One GOJO Plaza, Suite 300, AKRON, OH, 44311-1076, US

(21) Appl. No.: 11/460,841

(22) Filed: Jul. 28, 2006

(51) Int. Cl. H02K 7/02

(52) U.S. Cl. 74/572.1

(57) ABSTRACT

An auxiliary power supply includes a battery, a motor-generator and an inertial energy storage mass. The motor-generator draws power from the inertial energy storage mass to drive the motor-generator thereby creating electricity. As inertial energy is depleted from the drive mechanism during use, a battery recharges the inertial energy storage mass. The inertial energy storage mass includes a series of flywheels each having smaller disks contained therein. The disks translate radially with respect to the flywheels working with gravity to provide drive power to the motor-generator.

### TECHNICAL FIELD

The present invention pertains to auxiliary power supply systems, and more particularly to auxiliary power supply systems having a plurality of energy storage devices where at least one of the energy storage devices stores inertial energy.

### BACKGROUND OF THE INVENTION

There are numerous applications that exist for auxiliary power sources that can operate in the event that conventional utility power has been interrupted. For example, computer systems need to be isolated from short-term drop-outs and switching noise that commonly occur on utility power lines. Homeowners require backup systems to power furnaces or air conditioners. Office buildings also require backup power to maintain various systems in the event of a utility power outage. Hospitals are yet another example where auxiliary power is critical to maintaining life support equipment.

One type of auxiliary power source includes large multi-cell DC batteries that typically have a limited backup time measured in units of hours depending on the size of the connected load. Another type of auxiliary power source utilizes electromechanical systems that include an engine connected to an electrical generator. These electromechanical devices require fuel to keep the engine rotating resulting in a system that produces harmful exhaust gases. These systems may also generate a significant amount of noise undesirable for many situations. The amount of time that any of these systems may operate without being recharged or refueled is relatively limited.

What is needed is an auxiliary power supply that can supply power for an extended period of time without the detriment of both noise and air pollutants, and the expense of costly fuels. The embodiments of the subject invention obviate the aforementioned difficulties by providing a highly efficient auxiliary power supply that operates from the kinetic energy stored in an inertial energy storage device.

### BRIEF SUMMARY

A flywheel is a heavy rotating disk used as a repository for angular momentum. Flywheels can be used by small motors to store up energy over a long period of time and then release it over a shorter period of time, temporarily magnifying its power output for that brief period. The kinetic energy stored in a rotating flywheel is represented by the equation

E=½Iω²

where I is the moment of inertia of the mass about the center of rotation and ω (omega) is the angular velocity in radian units. A flywheel is more effective when its inertia is larger, as when its mass is located farther from the center of rotation either due to a more massive rim or due to a larger diameter. The similarity of the above formula will be noted to that of the kinetic energy formula E=½mv², where linear velocity v is comparable to the rotational velocity and the mass is comparable to the rotational inertia.

In accordance with the embodiments of the invention an auxiliary power supply system supplies electrical power to an associated load and includes a power monitoring device that can regulate the transmission of electrical power to the associated load. An associated external power supply, such as power supplied from conventional power lines, is also communicated to deliver power to the associated load through the power monitoring device. The auxiliary power supply system may also include first and second energy storage devices communicated to the power monitoring device, wherein the power monitoring device cycles between supplying auxiliary power from the first energy storage device and the second energy storage device.

In one embodiment of the subject invention the first energy storage device may store electrical energy and may comprise a battery having one or more cells. Additionally, the second energy storage device may store a different type of energy from that of the first energy storage device, which may be inertial energy.

One aspect of the embodiments of the subject invention may include a generator, which may be connected between the second energy storage device and the power monitoring device. The generator may be a motor generator operable to function in one mode as an electrical generator and in another mode as an electrical motor.

Another aspect of the embodiments of the subject invention may include a transmission operatively connected between the second energy storage device and the power monitoring device, wherein the transmission may include a gearbox having one or more planetary gears.

In yet another aspect of the embodiments of the subject invention may the second energy storage device may include a frame, an inertial energy storage portion having a fixed mass M operatively connected to the frame and an output shaft rotatably connected with respect to the frame, the output shaft being coupled to the inertial energy storage portion, which may include one or more flywheels having a plurality of disks rollingly connected with respect to each of the flywheels.

In one embodiment the flywheels may have an offset center of gravity with respect to an axis of rotation caused by the placement and/or movement of the disks within the flywheels respectively.

One aspect of the auxiliary power supply system according to the embodiments of the subject includes a power monitoring device that may cycle between supplying auxiliary power from the first energy storage device and the second energy storage device when the second energy storage device falls below a threshold level of inertial energy and more particularly below a threshold rotational speed.

Still another aspect of the auxiliary power supply system according to the embodiments of the subject includes a first energy storage device that is operable to recharge the second energy storage device.

According to the embodiments of the subject invention an inertial energy storage device may include a frame, an output shaft rotatably connected with respect to the frame, an inertial energy storage portion having a fixed mass M coupled to the output shaft, wherein the inertial energy storage portion includes, at least a first flywheel fixedly connected with respect to the output shaft and a plurality of disks rollingly connected with respect to the at least a first flywheel.

One aspect of the inertial energy storage device according to the embodiments of the subject invention includes at least a first flywheel having one or more slots fashioned on an interior of the at least a first flywheel that respectively receive the disks.

Another aspect of the inertial energy storage device according to the embodiments of the subject invention includes at least a first flywheel that comprises at least a first pair of flywheels, where each of the plurality of disks includes an axle fixedly connected to the disks respectively, wherein the axles are rollingly connected with respect to the at least a first pair of flywheels.

Yet another aspect of the inertial energy storage device according to the embodiments of the subject invention includes a plurality of brake members fixedly connected with respect to at least a first flywheel for arresting motion of the rollingly connected disks.

Still another aspect of the inertial energy storage device according to the embodiments of the subject invention includes the plurality of flywheels that is phase shifted with respect to the remaining flywheels.

### BRIEF DESCRIPTION OF THE DRAWINGS

FIG. 1 is a schematic representation of a power supply system for supplying power to a load according to the embodiments of the invention.

FIG. 2 is a perspective view of an inertial energy storage device according to the embodiments of the invention.

FIG. 3 is an end view of the flywheel of the inertial energy storage device according to the embodiments of the invention.

FIG. 4 is a perspective view of a disk according to the embodiments of the invention.

FIG. 5 is a side view of a flywheel according to the embodiments of the invention.

FIG. 6 is a side view of a flywheel according to the embodiments of the invention.

FIG. 6a is a side view of a flywheel according to the embodiments of the invention.

FIG. 7 is a schematic representation of a power monitoring device for controlling the supply of power to a load according to the embodiments of the invention.

### DETAILED DESCRIPTION OF THE INVENTION

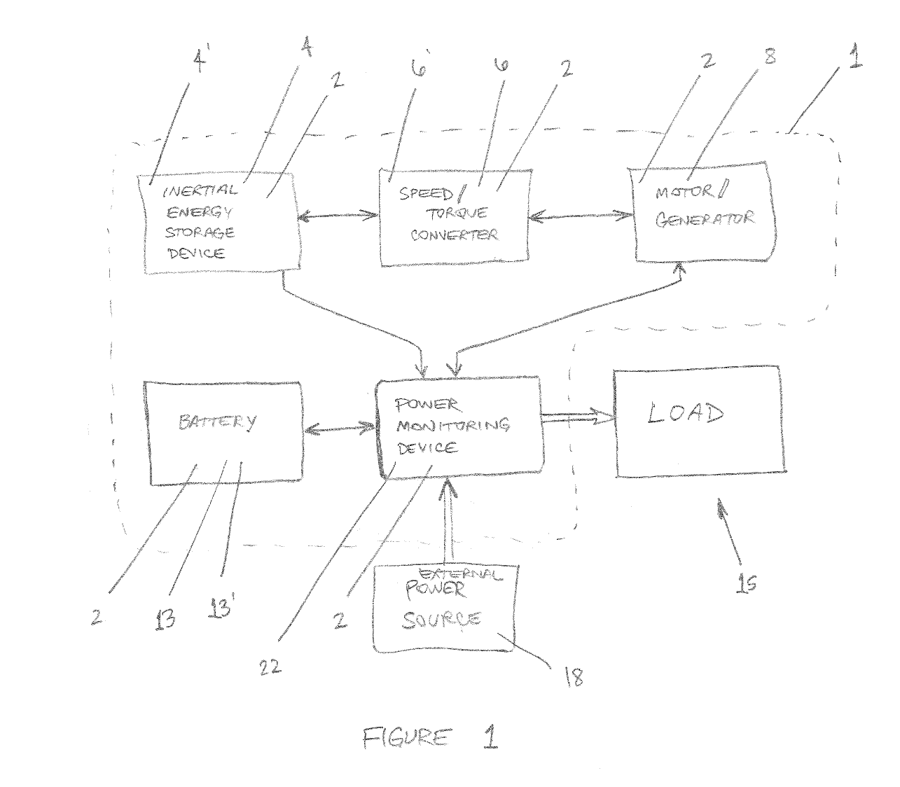

Referring now to the drawings wherein the showings are for purposes of illustrating embodiments of the invention only and not for purposes of limiting the same, FIG. 1 shows an auxiliary power supply system 1 for supplying electrical power as depicted within the dashed lines. The power supply system 1 may comprise a series of subsystems 2 interconnected to function in the presently described manner. The subsystems 2 may include a first energy storage device 4, which may be an inertial energy storage device 4′. By inertial energy storage device it is meant a repository that stores energy in the form of a moving mass. The inertial energy storage device 4′ may be interconnected to an electrical generator 8 through a transmission 6, which in one embodiment may be a planetary gear box 6′. The inertial energy storage device 4′ may alternatively be connected to the electrical generator 8 via other torque-speed converting means including but not limited to torque converters and fixed ratio gear boxes. However, any means may be used to connect the inertial energy storage device 4′, the transmission 6 and the generator 8 as is appropriate for use with the embodiments of the subject invention. Power may be drawn from the inertial energy storage device 4′ as during a power outage and directed to the electrical generator 8. The generator 8 will produce electrical power for supplying energy to a second energy storage device 13 and/or a designated load depicted generally at 15. The second energy storage device 13 may comprise one or more electrical energy storage cells as may be found in a battery 13′, of which the battery 13′ may also be connected to the load 15.

In this manner, electrical power may be supplied by the power supply system 1 to a load 15 from the battery 13′ and/or the generator 8. In other words, power supplied to the load 15 may be drawn from either of the first or second energy storage devices. The battery 13′ may be connected in parallel to a primary power source 18. Such power sources 18 are readily known in the art and may include electrical energy supplied from a utility power company through conventional transmission lines. In the event that primary power has been interrupted, a power monitoring device 22 may be incorporated to switch power sources thus maintaining a continuous supply of power to the load 15. In one embodiment, the power monitoring device 22 may engage the battery 13′ and/or the generator 5 in regulating the flow of energy between the devices and the associated load 15. In particular, the power monitoring device 22 may monitor the amount of energy remaining in each source and selectively engage the battery 13′ and/or the generator 5 to regulate the flow of energy from the power supply system 1. Accordingly, the power supply system 1 may draw power from one energy storage device and charge the other energy storage device, while supplying power to the load 15, as will be discussed in detail in a subsequent paragraph.

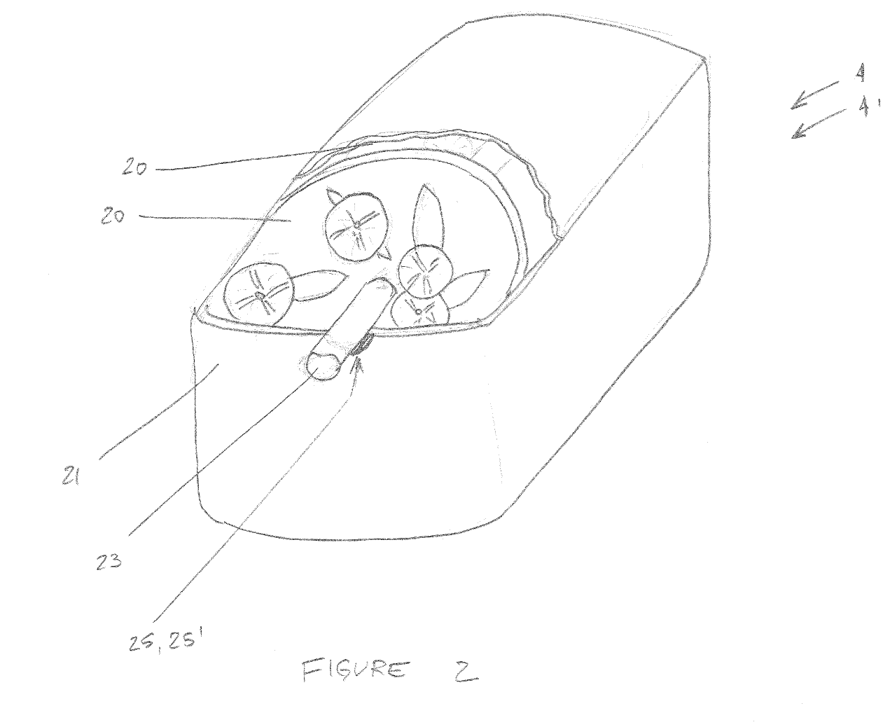

With reference now to FIG. 2, the inertial energy storage device 4′ may include a series of flywheels 20 mounted within a flywheel housing 21, where each flywheel 20 has a characteristic mass M. The flywheels 20 may be fixedly connected to a shaft 23 extending through a center of the flywheel 20. One shaft 23 may connect all of the flywheels 20 together into a single rotating unit. Accordingly, the single rotating unit will have a mass equal to the sum of the masses of the individual components, i.e. the flywheels 20 and shaft 23. The shaft 23 may subsequently be rotatably connected with respect to the flywheel housing 21 via bearings 25. In one embodiment, the bearings 25 may be magnetic bearings 25′, which incorporate non-contacting technology. The shaft 23 may be received within the magnetic bearings 25′ and may rotate therein without substantial frictional losses thereby helping to preserve the inertial energy stored in the mass of the flywheels 20 for conversion by the generator 8 as will be described further in a subsequent paragraph. While the aforementioned embodiment discusses the use of bearings 25 and in particular magnetic bearings 25′, it is to be construed that any means may be chosen to rotatably connect the shaft 23 to the flywheel housing 21 that significantly limits the loss of inertial energy stored in the flywheels 20. In addition to the use of magnetic bearings 25′, the housing 21 may be evacuated of air and/or other gases to limit losses due to windage. A person of ordinary skill in the art will understand the resistance caused by an object moving through ambient conditions, and more specifically the density of air at a particular elevation level. Accordingly, the housing 21 may be hermetically sealed substantially preventing air from entering the vacuum of the housing 21.

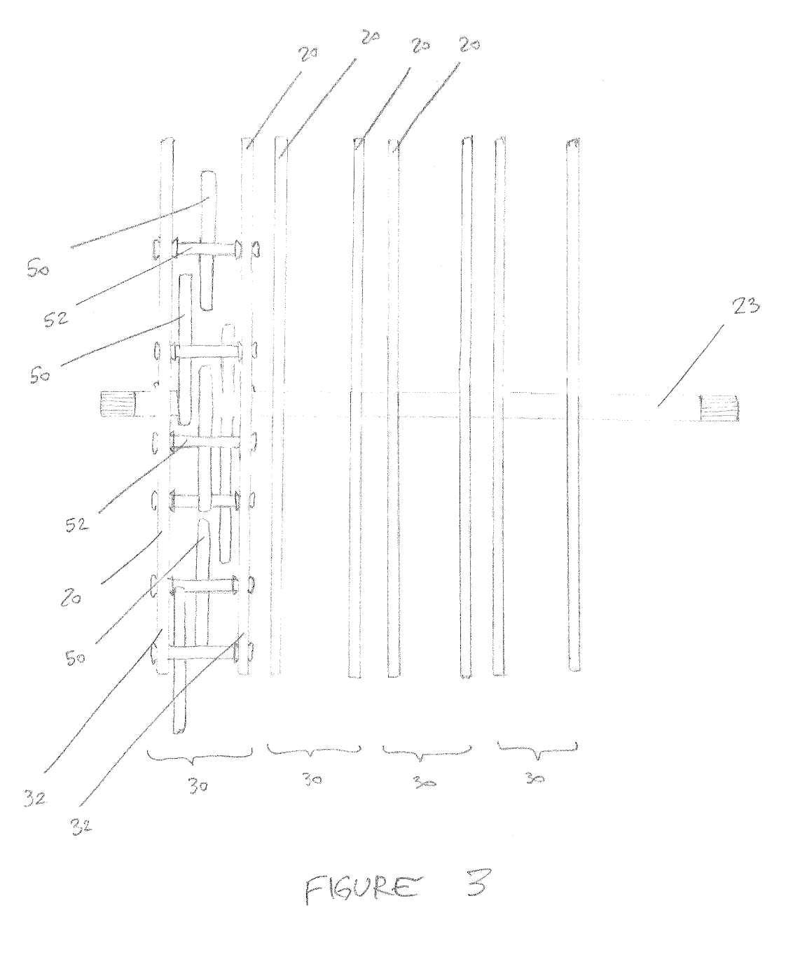

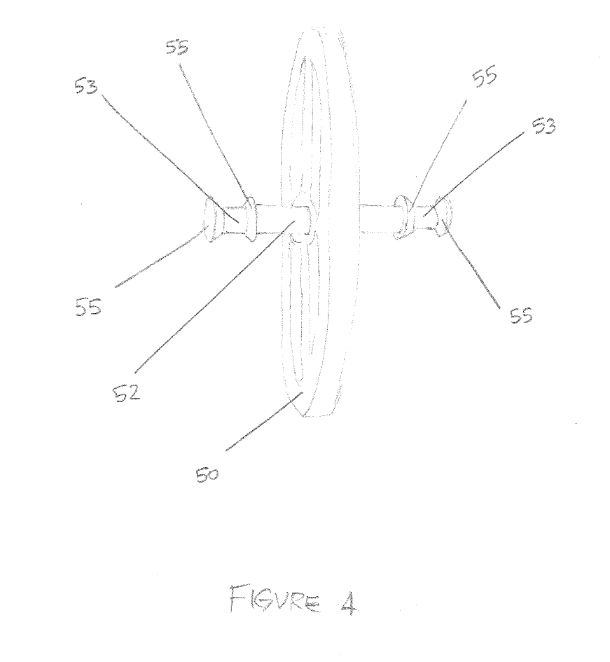

With continued reference to FIG. 2 and now to FIGS. 3 and 4, the flywheels 20 may be laterally spaced along the length of the shaft 23 in pairs or sets 30 each containing two flywheels 20. Each set 30 may function as supports for a plurality of disks 50 rotatably connected between the pair of flywheels 20. The disks 50 may each be fixedly mounted to an axle 52 that spans the distance between the pair of flywheels 20. As such, the length of the axles 52 may correspond to the spacing of the flywheels 20. Any length may be selected with sound engineering judgment as is appropriate for use with the embodiment of the subject invention. It will be readily seen that the disks 50 add to the mass of the inertial energy storage device 4′ thereby increasing the amount of inertia that can be stored in the power supply system 1. In this manner, each pair of flywheels 20 may include a set of disks 50 connected therebetween. In one embodiment, the inertial energy storage device 4′ may include eight (8) flywheels thus comprising four (4) pairs or sets of flywheels 20. To facilitate rotation of the disks 50 between the sets of flywheels 20, the flywheels 20 may be fashioned having one or more races 60 onto which the respective ends 53 of the axles 52 may roll as will be discussed in detail below. In this manner, the disks 50 are connected to rotate with respect to the flywheels 20 and the shaft 23. The disks 50 may be fashioned having guide ends 55 that align the axles 52 onto their respective races 60. In one embodiment, the guide ends 55 may be tapered to keep the disk from moving laterally with respect to the flywheels 20.

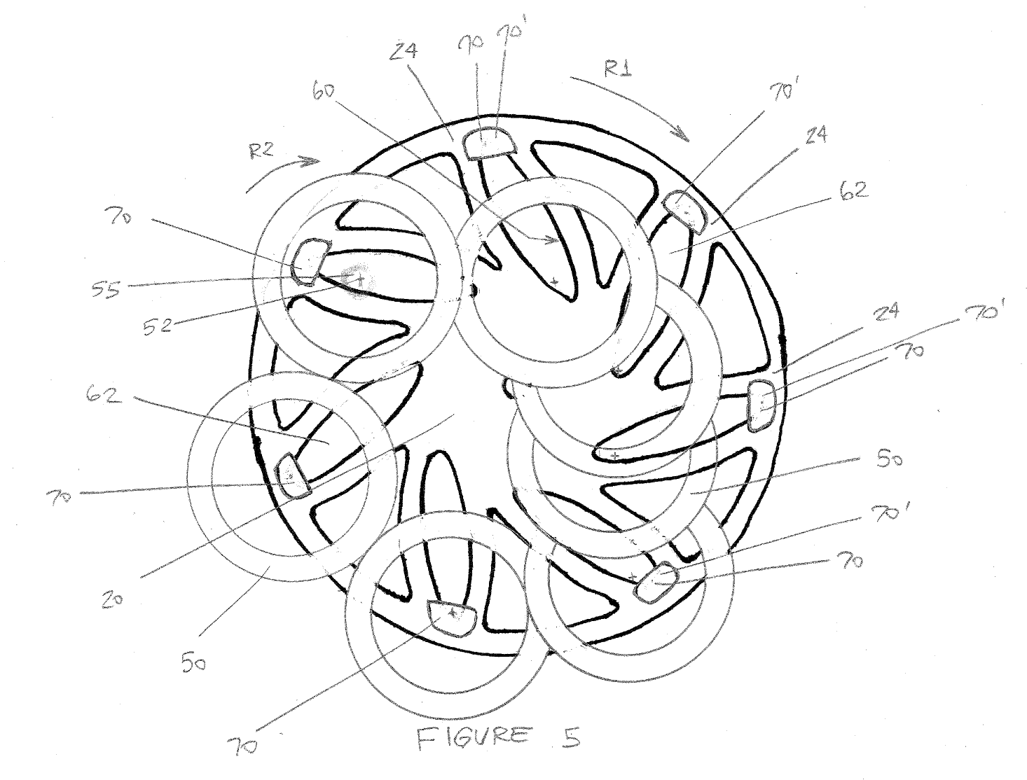

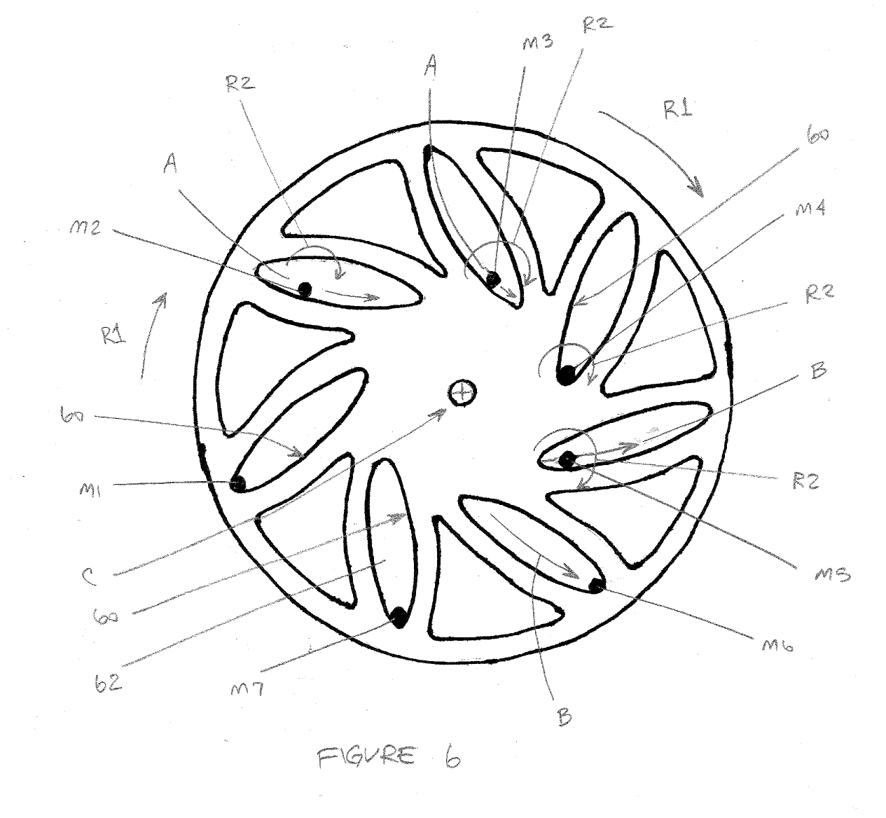

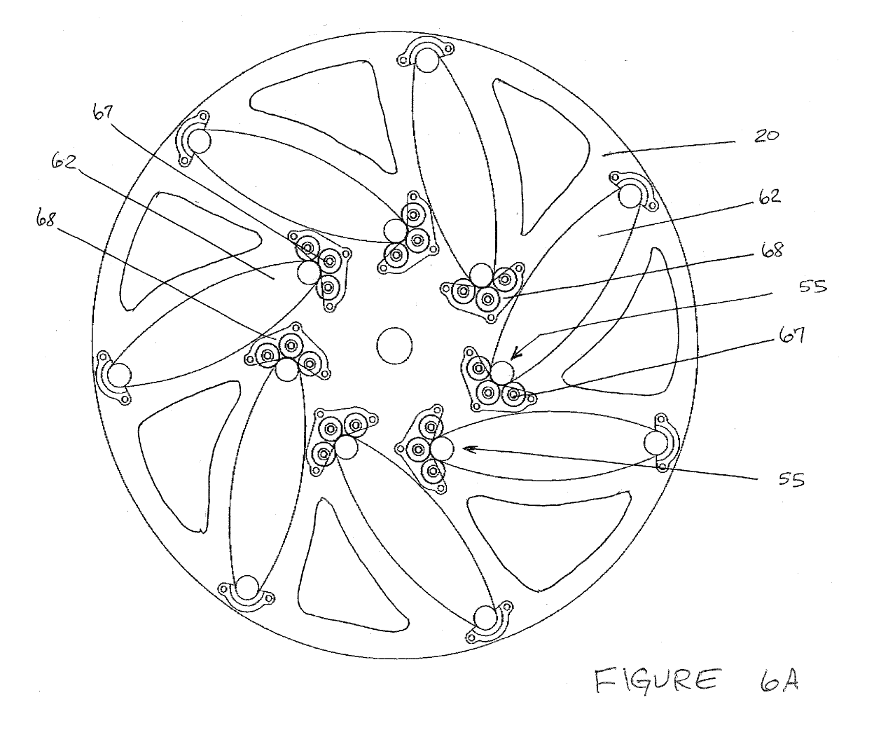

With continued reference to FIGS. 3 and 4 and now to FIGS. 5 and 6, a flywheel 20 may be constructed having a plurality of slots 62 fashioned on an interior of the flywheel 20. The slots 62 may have a generally elliptical shape, having a major and a minor axis, with curved surfaces that may function to receive an axle 52. In this manner, the curved surfaces of the slots 62 may form races 60 on which a disk 50 may rotate. In one embodiment, the flywheels 20 each include seven (7) slots 62 spaced equidistantly around the interior of the flywheel 20 and seven (7) corresponding disks 50. While the current embodiment describes the flywheels 20 having seven (7) slots 62, any number of slots 62 and any angular orientation of the slots 62 may be included as are appropriate for use with the embodiments of the subject invention. As the flywheels 20 rotate with the shaft 23, the disks 50 may translate or roll along the races 60 as the flywheels 20 rotate. In other words, upon reaching a specific point in the cycle of the rotating flywheel 20, a disk 50 will be pulled downward by gravity thus initiating the rotation of that particular disk 50. In this manner, gravity causes the disks 50 to move downward in an arcuate trajectory as guided by the configuration of the slots 62. For example, FIG. 6 depicts point masses M1-M7 in each of the respective slots 62 representing each of the disks 50. It is to be understood that the point masses represent each of the disks respectively and are used in the examples for illustrative purposes. A disk 50, represented by point mass M1, is positioned at one end of the corresponding slot 62. It will be readily seen that as the flywheel 20 is rotating in the direction R1, work is being done against gravity by the flywheel 20. The disk 50 in this position is stationary with respect to the flywheel 20. As the flywheel 20 continues to rotate, the slot 62 crosses a horizontal plane. This position is depicted by point mass M2, representing another disk 50. As such, gravity pulling the disk 50 downward, initiates the movement of the disk 50 along the arcuate trajectory A as guided by the slot 62. The disk 50 continues along this trajectory, exemplified by point mass M3, until it reaches the distal end of the slot 62, shown by point mass M4. Once the disk 50 reaches this position momentum continues to rotate the disk 50 seated in the vertex of the slot 62 until the angle of the slot 62 once again allows gravity to pull the disk 50 downward further rotating the disk 50 in the direction R2. It is noted here that the races 60 and the guides 55 of the axle 52 may be fashioned having smooth surfaces so as to minimize frictional losses between the axle 52 and the flywheel 20. In one embodiment, the surface finish of the slots 62 and the guides of the axles 52 may be substantially 15. However, any surface finish may be used that minimizes frictional losses as chosen with sound engineering judgment. Thus, as the flywheel 20 rotates, in the direction R1, each of the successive disks 50 will be drawn upward by the flywheel 20 through approximately one quadrant of the cycle and downward by gravity through the remainder of the cycle. It will be appreciated by a person of ordinary skill in the art that rotation of the flywheels 20 will produce a centrifugal force that drives the disks 50 radially outward. If the radially outward force is sufficiently large enough, the disks 50 will be prevented from rolling along their respective races 60. As such, a rotational speed of the flywheels 20 may be chosen such that the centrifugal force against the disks 50 is small enough to allow the disks 50 to roll through their respective slots 62. In one embodiment, the designated rotational speed of the flywheels may be less than 30 RPMs. More specifically, the designated rotational speed may be between 20 and 30 RPMs and more particularly may be substantially 25 RPMs.

With reference to FIGS. 4 through 6a, as mentioned above, disk 50 upon reaching the distal end of the slot 62, as exemplified by point mass M4, may spin in place until the flywheel 20 rotates further to the point where the disk 50 once again is drawn by gravity along the slot 62. A friction reducing device such as a bearing 67 may be placed proximate to the end 65 of the slot 62 so as to receive the guide 55 of the disk 50. In this manner, as the disk 50 is rotating in the position at the end 65 of the slot 62 the bearing 67 may receive the guide 55 thereby allowing the disk 50 to spin with reduced friction. It is to be construed that each end 65 of each of the slots 62 on all of the flywheels 20 may include bearings 67 positioned in the aforementioned manner. However, any configuration bearings 67 with respect to the ends 65 of the slots 62 may be chosen with sound engineering judgment. The bearings 67 may be roller bearings having multiple bearing members or contacting surfaces for receiving the respective guides 55 of the disks 50. Alternatively, the bearings 67 may be magnetic bearings or any other type or configuration of friction reducing device as is appropriate for use with the embodiments of the subject invention. FIG. 6a depicts the bearings 67 fastened onto a side of the flywheel 20 having a retainer 68. Two bearings 67 may be included per flywheel 20; one on each side for each of the respective slots 62. It is noted that the depicted configuration of bearing 67 is for illustrative purposes and as such other configurations, placement and installation of the bearings 67 may be utilized without departing from the intended scope of coverage for the embodiments of the subject invention.

With continued reference to FIG. 5, the flywheels 20 may include brakes 70 which arrest the rotating motion of the disks 50. In one embodiment, the brakes 70 may be respectively affixed proximate to the end of the slots 62 at the rim 24 of the flywheel 20. The brake 70 may comprise a friction pad 70′ that engages the axle 52. As mentioned above, at various points in the cycle, the disks 50 will be rolling along each respective race 60 as the flywheels 20 rotate. When the disk 50 reaches the end of the slot 62 at the rim 24 of the flywheel, it contacts the brake 70 bringing the rotating disk 50 to a stop thereby translating the inertial energy of the rotating disk 50 to the flywheel 20. The disk 50 will remain stationary through that portion of the cycle until it reaches an angle that once again allows the disk 50 to begin rotating along the slots 62 in a manner as previously described. Thus, it will be readily seen that each successive rotating disk 50 will transfer its inertia at prescribed intervals correlating to the configuration of the slots 62. In one embodiment, a disk 50 may contact each respective brake 70 at approximately every 51.4 degrees throughout the revolution of one set of flywheels 20. Each set of flywheels 20 may be substantially identical to the others. However, each set of flywheels 20 may be shifted in their angular orientation around the shaft 23. In one embodiment, the sets of flywheels 20 may be phase shifted approximately 12.8 degrees with respect to each other thus enabling at least one disk 50 to contact its respective brake 70 every 12.8 degrees continuously throughout each revolution of the shaft 23. While the present embodiment describes the power supply system 1 having four sets of flywheels and seven disks per set of flywheels, it is to be construed that any number of the flywheels and any number of disks may be used in the inertial energy storage device 4′ as chosen with sound engineering judgment. In this manner, all of the disks 50 may be substantially equidistantly spaced around the circumference of the shaft 23. However, any radial position or spacing of the disks 50 around the circumference of the shaft 23 may be chosen as is appropriate for use with the embodiments of the subject invention.

As the flywheels 20 rotate, output power is available from the shaft 23 proportionate to the speed of rotation of the shaft 23 and the mass of the flywheels 20 of the inertial energy storage device 4′. As previously mentioned, the inertial energy storage device 4′ may be connected, via shaft 23, to a transmission 6 thereby conveying the inertial energy stored in the flywheels 20 to a generator 8 for converting the inertial energy into electrical energy. In one embodiment, the transmission 6 may function to convert the output speed, and consequently the torque as well, of the shaft 23 to a speed suitable for driving the rotor of the generator 8, which may range from 1500 to 2500 RPMs. In this manner, the transmission 6 may comprise a gear reducer having one or more sets of planetary gears, not shown. However any gear reducing means for converting the speed and torque of the inertial energy storage device may be chosen with sound engineering judgment.

With continued reference to FIGS. 1 and 2, the output of the transmission 6 or planetary gear box 6′ may be coupled to the generator 8. In one embodiment, the generator 8 may be a reversible motor-generator 8′, which functions as a motor or a generator depending on the particular mode of operation as will be discussed in detail in the following paragraphs. The motor-generator 8 may be an AC or DC generating device having a rotor and a stator, neither shown, that work in conjunction with each other to produce either an electrical power output or mechanical power output having parameters of angular velocity and torque. The motor-generator device has two principal components: a field winding and an armature winding. A field, or excitation, winding is a coil or group of coils through which an electrical current is passed. The excitation current sets up a magnetic field in the vicinity of the coil and includes what is commonly referred to as “lines of magnetic flux”. An armature winding is a coil, separate from the excitation coil, which cuts through the lines of magnetic flux created by the field winding and excitation current. This cutting action results in an induced electromotive force (EMF) on the armature winding according to well-established principles of electromagnetic theory. When an electrical load is connected to the armature winding, an electrical current will be made to flow because of the induced EMF. Thus an output voltage and current are generated by the generator 8 when mechanical input is applied to the rotor. As such, the rotor is the rotating part of the motor-generator 8′ that may be coupled to the output of transmission 6. As the rotor turns within the magnetic fields of the stator, current flow will be induced in the windings of the rotor for use by the power supply system 1. In the opposite mode of operation, current may be supplied to the armature winding thus producing a torque that drives the rotor. In that the operation of motors and generators are well known in the art, no further explanation will be offered at this time.

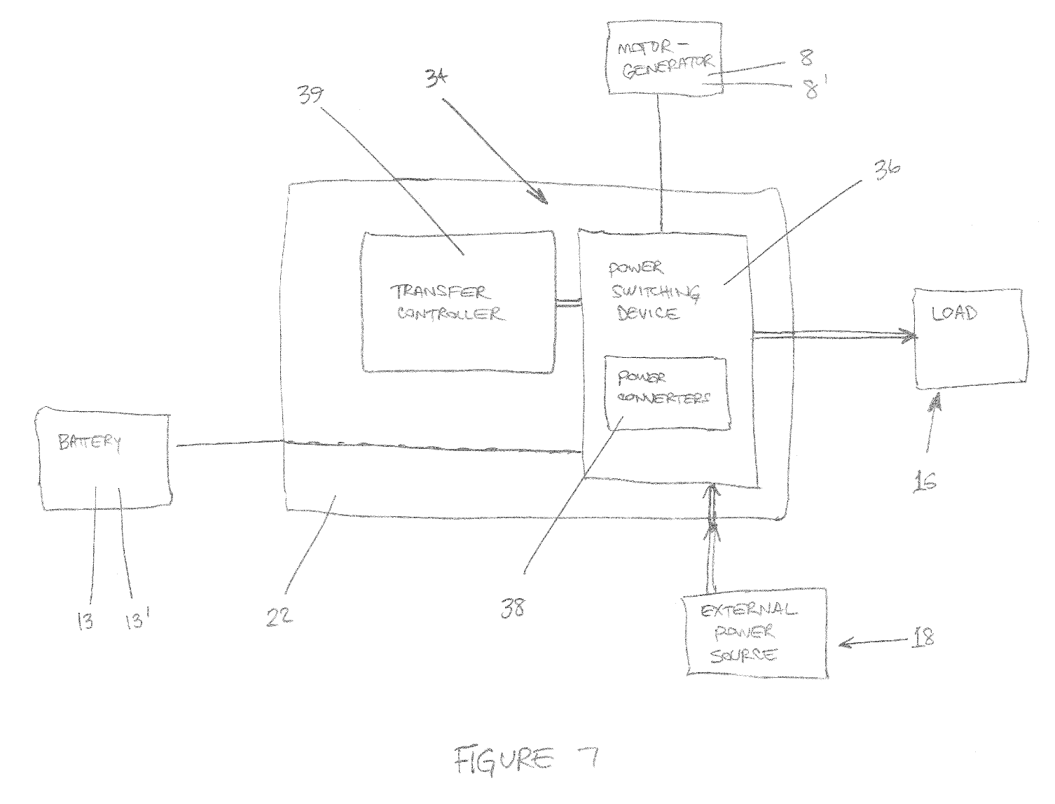

With reference again to FIGS. 1 and 7, the power supply system 1 may include a power monitoring device 22 as previously mentioned, which may incorporate a switchgear 34 for switching and controlling power through the power supply system 1. The switchgear 34 may be an automatic type switchgear that transfers power to the load 15 between an external power source 18 and the power supply system 1. One example of an external power source 18 may be power delivered over standard transmission lines from a local power company. When power from the external power source 18 is interrupted, the power monitoring device 22 may sense the interruption and switch power to the load 15 from the external power source 18 to the power supply system 1. In this manner, the power supply system 1 may be alternate or auxiliary source of power ready for immediate use in the event of a power outage. Thus, the power monitoring device 22 may sense and automatically transfer the connection of power to the load 15 between an external power source 18 and the power supply system 1.

With reference to FIG. 7, in one embodiment, the switchgear 34 may comprise one or more components including a power switching device 36 to shift the load circuits to and from the power supply system 1 and a transfer controller 39 to monitor the status of the external power source 18 and the power supply system 1. The power switching device 36 may utilize a “circuit breaker” or a “contactor” type switch to transfer the loads between the external power source 18 and power supply system 1. In one embodiment, solid state circuitry may be incorporated, such as that found in Silicon Controller Rectifiers (SCR). However any type and/or configuration of devices may be used to transfer power between the power supplies. As the load 15 may require a specific type electrical power, for example DC power as opposed to AC power, the power from the generator 8 may need conditioned or rectified. For example, the load 15 may require 24 VDC power whereas output from the generator 8 may provide AC power. Accordingly, the power supply system 1 may include power converters 38 for conditioning the power. Additionally, the magnitude and frequency of the power may also need converted. Power converters 38 may include transformers, rectifiers, variable frequency devices and/or other solid state circuitry, e.g. DC to DC power converters, that functions to condition the power as needed.

With continued reference to FIG. 7, the transfer controller 39 may provide logic based circuitry that tells the power switching device 36 under what conditions the power connection is to be switched between the sources of electrical power. Logic-based processors such as microprocessors may be used to perform logic functions based on feedback signals generated by sensors within the power supply system 1. In one embodiment, power supply system 1 may utilize torque and/or speed sensors that monitor the speed of the shaft 23. Additionally, the power supply system 1 may incorporate current and/or voltage sensors that detect power levels in the external power source 18, the load 15 and the output from the generator 8 and the battery 13′. It is to be construed that any type, quantity and configuration of sensors may be chosen with sound engineering judgment for use with the embodiments of the subject invention. In this manner, the transfer controller 39 may provide supervisory circuits to constantly monitor the condition of the power sources and thus provide the intelligence necessary for the switchgear 34 to adjust the power output accordingly.

With reference again to FIG. 1, the second energy storage device 13 may be a multi-cell battery 13′. The battery 13′ may have sufficient storage capacity to supply power for a given period of time up to a maximum load. Power for the load 15 may be supplemented by inertial energy converted from the inertial energy storage device 4′. Each of these two energy storage devices 4′, 13′ may function in conjunction to provide an auxiliary source of power to the load 15 as regulated by the power monitoring device 22, which will be discussed further in a subsequent paragraph. In one embodiment, the power supply system 1 may be configured to supply power at a rate of up to 30 kW to a prescribed load.

With reference once again to FIG. 1, the operation of the power supply system 1 will now be described. The power supply system 1 may be connected to a load 15, such as that found in residential or commercial buildings. Well known electrically operated devices may be connected to draw power from the power supply system 1 including for example copiers, lights, compressors, heating units and the like. External source power 18 may also be connected to the load 15 and may function as a primary source of electrical power for use by the load devices. In one embodiment, the external power source 18 may be connected to the load 15 through the power monitoring device 22 in a manner consistent with the above described embodiments of the subject invention. When the power flow from the external power source 18 is interrupted, the power monitoring device 22 may sense the drop in voltage and/or current and automatically switch the connection of the power to the load 15 from the external power source 18 to the power supply system 1.

In one embodiment, when supply power for the electrically operated devices, i.e. load 15, is switched to the power supply system 1, the load 15 may be directly connected to battery 13′ through a power converter 38 or any power conditioning circuit as may be required. For example, power from the battery 13′ may be drawn as DC electrical power and converted to 115 VAC power by a transformer and other circuitry for use by the load 15. While power is being supplied to the load 15 via battery 13′, electrical power may be supplemented by the inertial energy storage device 4′ as converted by the generator 8 and supplied to the load 15 in a parallel circuit as controlled by the power monitoring device 22. Therefore power from each of the first and second energy storage devices 4′, 13′ may be electrically communicated to the power monitoring device 22. In this manner, electrical power from the power supply system 1 may be supplied from two dissimilar sources of stored energy, namely an electrical energy source and a kinetic energy source. It will be realized by a person of ordinary skill in the art that as kinetic energy from the flywheels 20 is drawn from the inertial energy storage device 4′ the rotational speed of the shaft 23 and the flywheels 20 will decrease thereby reducing the inertial energy stored therein. The power monitoring device 22 may sense the decrease in rotational speed and automatically shi ft the supply of power to the load 15 from both the battery 13′ and the inertial energy storage device 4′ to power supplied from only the battery 13′. Thus, the load 15 will temporarily be supplied by electrical power from a single source of stored energy. In conjunction, the power monitoring device 22 may shift operating modes of the motor-generator 8′ from converting the inertial energy stored in the flywheels 20 to supplying energy from the battery 13′ to speed up the flywheels 20. In this mode of operation, power from the battery 13′ may supply power not only to the load 15 but also to the motor-generator 8′ thus recharging the inertial energy storage device 4′. When the inertial energy storage device 4′ reaches its designated rotational speed, the power monitoring device 22 may once again shift operating modes of the motor-generator 8′ thereby supplying power to the load 15 from both sources of stored energy 4′ 13′. The frequency at which the power monitoring device 22 shifts between operating modes may depend on a threshold rotational speed of the shaft 23 of the inertial energy storage device 4′. In one embodiment, the threshold speed of shaft 23 may be within a range equal to the designated rotational speed less 5 RPMs. In other words, the threshold speed may be between 20 and 25 RPMs. More particularly, the threshold speed may be substantially 23 RPMs. The threshold speed represents a minimum value that the inertial energy storage device 4′ may rotate while operating the motor-generator 8′ in generator mode. Accordingly, the frequency of switching between modes of operation may depend on the load 15. A larger load may draw energy from the power supply system 1 at a faster rate. The converse also holds true.

In summary, the power supply system 1 may control the supply of power to the load 15 from between two sources of stored energy 4′ 13′. The power monitoring device 22 may shift between modes of operation where both sources of stored energy, i.e. the battery 13′ and inertial energy storage device 4′, supply power to the load 15 to one source of stored energy, i.e. the battery 13′, supplies power to the load 15, As the inertial energy storage device 4′ drops to a minimum threshold energy level, the power monitoring device 22 triggers the operating modes of the motor-generator 8′. When the motor-generator 8′ is shifted into motor mode, power supplied to the motor-generator 8′ from the battery 13′ will produce an output torque transferred through transmission 6 to the inertial energy storage device 4′ until the shaft 23 is rotating again the designate operating speed. When the motor-generator 8′ is shifted into generator mode, power from the inertial energy storage device 4′ is supplemented with power from the battery 13′ to meet the demands of the load 15. Thus, an efficient power supply system 1 is provided that can supply electrical power for an extended length of time during a power outage.

It will be appreciated by persons of ordinary skill in the art that the power supply system 1 contains a finite amount of stored energy. Once the subject power outage has ended, the power supply system 1 may be configured to draw power from the external power source 18 to recharge the battery 13′ and/or the inertial energy storage device 4′ for use at a future time. In this manner, the power supply system 1 maintains a constant state of readiness to supply power in the event of a power outage.

The invention has been described herein with reference to the preferred embodiment. Obviously, modifications and alterations will occur to others upon a reading and understanding of this specification. It is intended to include all such modifications and alternations in so far as they come within the scope of the appended claims or the equivalence thereof.

What is claimed is:

1. An auxiliary power supply system for supplying electrical power to an associated load, comprising:
a power monitoring device adapted to regulate the transmission of electrical power to an associated load, wherein an associated external power Supply is selectively operatively communicated to deliver power through the power monitoring device to the associated load;
a first energy storage device operatively communicated to the power monitoring device;
a second energy storage device operatively communicated to the power monitoring device; and,
wherein the power monitoring device cycles between supplying auxiliary power from the first energy storage device and the second energy storage devices.

2. The auxiliary power supply system as defined in claim 1, wherein the second energy storage device stores electrical energy.

3. The auxiliary power supply system as defined in claim 2, wherein the second energy storage device is a battery.

4. The auxiliary power supply system as defined in claim 2, wherein the first energy storage device stores inertial energy.

5. The auxiliary power supply system as defined in claim 4, further comprising:
a generator operatively connected between the first energy storage device and the power monitoring device.

6. The auxiliary power supply system as defined in claim 5, wherein the generator is a motor generator operable to function in one mode as an electrical generator and in another mode as an electrical motor.

7. The auxiliary power supply system as defined in claim 5, further comprising:
a transmission operatively connected between the first energy storage device and the power monitoring device.

8. The auxiliary power supply system as defined in claim 7, wherein the transmission is gearbox having one or more planetary gears.

9. The auxiliary power supply system as defined in claim 4, wherein the first energy storage device comprises:
a frame;
an inertial energy storage portion having a fixed mass M operatively connected to the frame;
an output shaft rotatably connected with respect to the frame, the output shaft being coupled to inertial energy storage portion.

10. The auxiliary power supply system as defined in claim 9, wherein the inertial energy storage portion comprises:
at least a first flywheel.

11. The auxiliary power supply system as defined in claim 10, wherein the flywheel is fixedly connected with respect to the shaft; and, further comprising:
a plurality of disks rollingly connected with respect to the at least a first flywheel.

12. The auxiliary power supply system as defined in claim 11, wherein the at least a first flywheel has an offset center of gravity with respect to an axis of rotation.

13. The auxiliary power supply system as defined in claim 4, wherein the power monitoring device cycles between supplying auxiliary power from the first energy storage device and the second energy storage devices when the second energy storage device falls below a threshold level of inertial energy; and,
wherein the first energy storage device is operable to recharge the second energy storage device.

14. An inertial energy storage device, comprising:
a frame;
an output shaft rotatably connected with respect to the frame;
an inertial energy storage portion having a fixed mass M coupled to the output shaft; and,
wherein the inertial energy storage portion includes:
at least a first flywheel fixedly connected with respect to the output shaft; and,
a plurality of disks rollingly connected with respect to the at least a first flywheel.

15. The inertial energy storage device as defined in claim 14, wherein the at least a first flywheel includes one or more slots fashioned on an interior of the at least a first flywheel that respectively receive the disks.

16. The inertial energy storage device as defined in claim 14, wherein the at least a first flywheel comprises at least a first pair of flywheels; and
wherein each of the plurality of disks includes an axle fixedly connected to the disks respectively, wherein the axles are rollingly connected with respect to the at least a first pair of flywheels.

17. The inertial energy storage device as defined in claim 16, further comprising:
a plurality of brake members fixedly connected with respect to at least a first flywheel for arresting motion of the rollingly connected disks.

18. The inertial energy storage device as defined in claim 15, wherein the at least a first flywheel comprises a plurality of flywheels, and
wherein each of the plurality of flywheels is phase shifted with respect to the remaining flywheels.

19. The inertial energy storage device as defined in claim 18, wherein the phase shift is substantially 12.5 degrees.

20. The inertial energy storage device as defined in claim 15, wherein the rotational speed of the output shaft is less than 30 RPMs.
